(19) United States
(12) Patent Application Publication
(10) Pub. No.: US 2012/0323602 A1
(43) Pub. Date: Dec. 20, 2012

(54) PHARMACY WORK QUEUE

(75) Inventors: HUGH RYAN, LEE'S SUMMIT, MO (US); BRENT NIGHTINGALE, KANSAS CITY, MO (US); STACEY GRAY, OLATHE, KS (US)

(73) Assignee: CERNER INNOVATION, INC., OVERLAND PARK, KS (US)

(21) Appl. No.: 13/164,192

(22) Filed: Jun. 20, 2011

(51) Int. Cl. G06Q 50/00; G06Q 10/00

(52) U.S. Cl. 705/3

(57) ABSTRACT

Methods, computer systems, and computer-readable media for generating a pharmacy work queue are provided. Clinical parameters are received along with a request for the pharmacy work queue. Patients at a healthcare facility who satisfy the clinical parameters are identified, and the pharmacy work queue is generated. The pharmacy work queue comprises an indication of the patients who satisfy the clinical parameters.

### BACKGROUND

Due to the increasing complexity of medicine, patients are best served by a healthcare team. Pharmacists are integral members of this healthcare team, especially in a hospital setting. Pharmacists are called upon to manage medication profiles of a wide variety of patients in the hospital. For example, pharmacists are often given the responsibility to make sure that certain medications are maintained within a therapeutic range, that medications are not prescribed that may cause an adverse drug reaction with an existing medication already being taken by a patient, and that lab results are monitored to make sure that the medications are not causing problems for a patient.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention are directed to methods, computer systems, and computer storage media for generating and displaying a pharmacy work queue. In brief and at a high level, the present embodiments are designed to automatically generate and display a list of patients in a healthcare facility with pharmaceutical needs. Pharmacists can use the list to help them determine which patients need to be monitored and to help organize their workflows. Patients are included on the list or work queue because they satisfy certain clinical parameters. The clinical parameters may be set by the healthcare facility or selected by the pharmacist.

### BRIEF DESCRIPTION OF THE DRAWINGS

Embodiments are described in detail below with reference to the attached drawing figures, wherein:

FIG. 1 is a block diagram of an exemplary computing environment suitable to implements embodiments of the present invention;

FIG. 2 is a block diagram of an exemplary computing system environment suitable for generating a pharmacy work queue;

FIG. 3 depicts a flow diagram illustrating a method for generating a pharmacy work queue suitable to implement embodiments of the present invention;

FIG. 4 depicts a flow diagram illustrating a method for generating clinical indicator alerts suitable to implement embodiments of the present invention;

FIG. 5 depicts an exemplary graphical user interface for displaying a pharmacy work queue in accordance with an embodiment of the present invention;

FIG. 6 depicts an exemplary graphical user interface for enabling a user to customize and build a pharmacy work queue in accordance with an embodiment of the present invention;

FIG. 7 depicts an exemplary graphical user interface for displaying a pharmacy work queue for renal patients in accordance with an embodiment of the present invention; and

FIG. 8 depicts an exemplary graphical user interface for displaying a pharmacy work queue for patients on antibiotics in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, computer systems, and computer storage media for generating and displaying a pharmacy work queue. Embodiments are designed to automatically generate and display a list or queue of patients in a healthcare facility with pharmaceutical needs. Pharmacists can use the list to help them determine which patients need to be monitored and to help organize their workflows. Patients are included on the list or work queue because they satisfy certain clinical parameters. The clinical parameters may be set by the healthcare facility or selected by the pharmacist.

Accordingly, in one embodiment, the present invention is directed toward one or more computer storage media having computer-executable instructions embodied thereon that, when executed, facilitate a method of generating a pharmacy work queue. A clinical parameter is received along with a request for a pharmacy work queue. A patient at a healthcare facility is identified who satisfies the clinical parameter. A pharmacy work queue is generated and displayed; the pharmacy work queue comprises an indication of the patient who satisfies the clinical parameter.

In another embodiment, the present invention is directed toward one or more computer storage media having computer-executable instructions embodied thereon that, when executed, facilitate a method of generating clinical indicator alerts for a pharmacist at a healthcare facility. A collection of clinical parameters is received, and a pharmacy work queue is generated and displayed. The pharmacy work queue comprises a list of patients at the healthcare facility who satisfy the collection of clinical parameters. A clinical indicator alert associated with a clinical parameter is identified, and a patient is determined to satisfy the clinical indicator alert. The clinical indicator alert is generated and displayed on the pharmacy work queue.

In yet another embodiment, the present invention is directed toward one or more computer storage media, executable by a computing device, to display a graphical user interface for displaying a pharmacy work queue. The graphical user interface comprises a build list display area configured to enable a user to select a clinical parameter from a set of clinical parameters and a pharmacy work queue display area configured to display a list of patients who satisfy the clinical parameter.

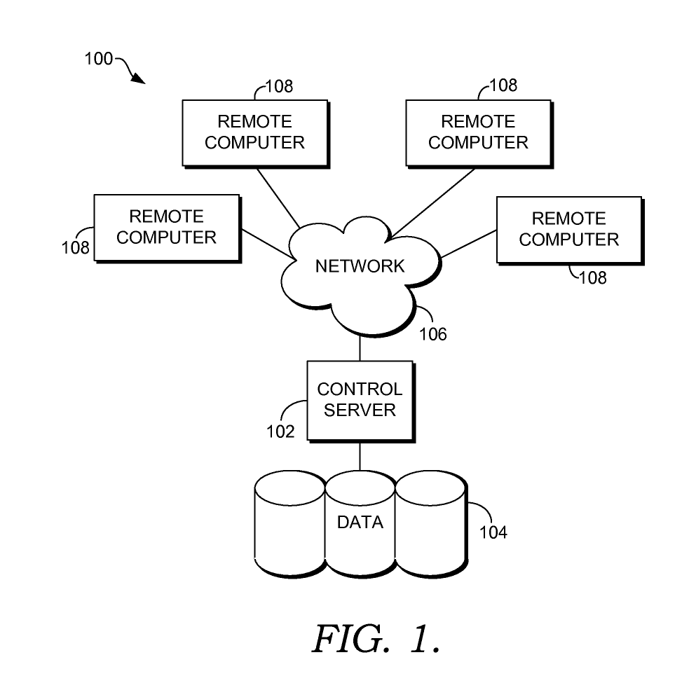

Having briefly described embodiments of the present invention, an exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

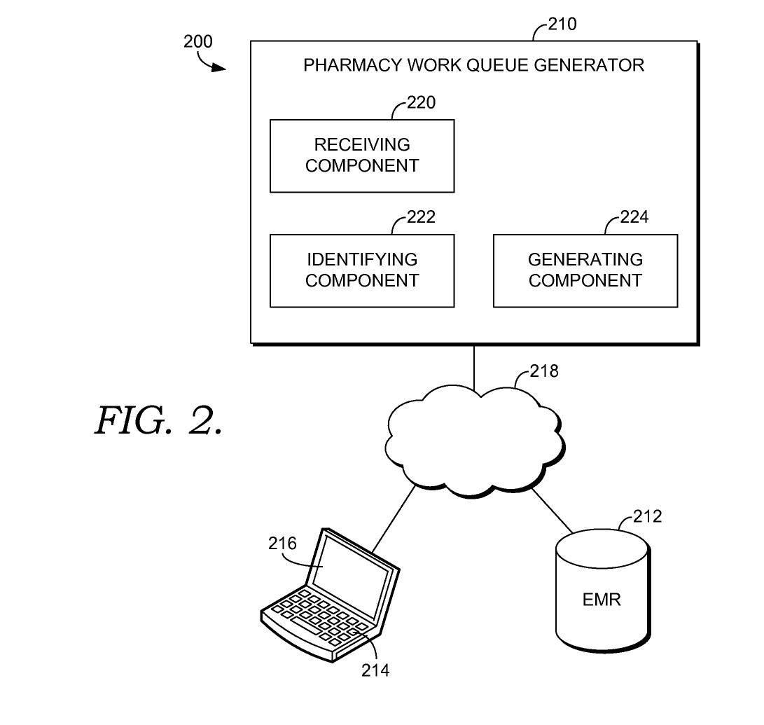

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a pharmacy work queue generator 210, an electronic medical record (EMR) 212, and an end-user computing device 214 with a display screen 216 all in communication with one another via a network 218. The network 218 may include, without limitation, one or more local area networks (LANs) and/or wide area networks (WANs). Such networking environments are commonplace in offices, enterprise-wide computer networks, intranets and the Internet. Accordingly, the network 218 is not further described herein.

In some embodiments, one or more of the illustrated components/modules may be implemented as stand-alone applications. In other embodiments, one or more of the illustrated components/modules may be integrated directly into the operating system of the pharmacy work queue generator 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the pharmacy work queue generator 210 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The EMR 212 may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

In embodiments, the EMR 212 is configured to be searchable for one or more of the items stored in association therewith. The information stored in association with the EMR 212 may be configurable and may include any information relevant to healthcare providers. The content and volume of such information are not intended to limit the scope of embodiments of the present invention in any way. Further, though illustrated as a single, independent component, the EMR 212 may, in fact, be a plurality of storage devices, for instance, a database cluster, portions of which may reside on the pharmacy work queue generator 210, the end-user computing device 214, any of the remote computers 108 or the control server 102 of FIG. 1, and/or any combination thereof.

As shown, the end-user computing device 214 includes a display screen 216. The display screen 216 is configured to display information to the user of the end-user computing device 214, for instance, information relevant to communications initiated by and/or received by the end-user computing device 214, information concerning patients, graphical displays of work queues, and/or the like. Embodiments are not intended to be limited to visual display but rather may also include audio presentation, combined audio/visual presentation, and the like. The end-user computing device 214 may be any type of display device suitable for presenting a GUI. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions.

Components of the pharmacy work queue generator 210 may include a processing unit, internal system memory, and a suitable system bus for coupling various system components, including one or more data stores for storing information (e.g., files and metadata associated therewith). The pharmacy work queue generator 210 typically includes, or has access to, a variety of computer-readable media.

The computing system environment 200 is merely exemplary. While the pharmacy work queue generator 210 is illustrated as a single unit, it will be appreciated that the pharmacy work queue generator 210 is scalable. For example, the pharmacy work queue generator 210 may in actuality include a plurality of computing devices in communication with one another. Moreover, the EMR 212, or portions thereof, may be included within, for instance, the pharmacy work queue generator 210 as a computer-storage medium. The single unit depictions are meant for clarity, not to limit the scope of embodiments in any form.

As shown in FIG. 2, the pharmacy work queue generator 210 comprises a receiving component 220, an identifying component 222, and a generating component 224. In some embodiments, one or more of the components 220, 222, and 224 may be implemented as stand-alone applications. In other embodiments, one or more of the components 220, 222, and 224, may be integrated directly into the operating system of, for example, any of the remote computers 108 or the control server 102 of FIG. 1, or the end-user computing device 214 of FIG. 2. The components 220, 222, and 224 illustrated in FIG. 2 are exemplary in nature and in number and should not be construed as limiting. Any number of components may be employed to achieve the desired functionality within the scope of embodiments hereof.

The receiving component 220 is configured to receive one or more clinical parameters. In one embodiment, the clinical parameters may be received from a pharmacist. The pharmacist may wish to construct a personalized pharmacy work queue of patients that have particular pharmaceutical concerns. The pharmacist selects one or more clinical parameters from a pre-defined list of clinical parameters in order to build a customized list of patients. The pre-defined list of clinical parameters may comprise parameters associated with location, activities, orders, laboratory, microbiology, and/or diagnosis. By way of example, a pharmacist at a hospital may wish to generate a pharmacy work queue made up of patients located in a particular wing of the hospital who are suffering from acute kidney injury and are on the drug Vancomycin (a renally-excreted drug). To do this, the pharmacist would select parameters associated with location, diagnosis, and orders. These parameters, in turn, would be received by the receiving component 220. In another embodiment, the pharmacist may be able to customize a set of parameters instead of selecting from the pre-defined list of parameters.

In another embodiment of the invention, the receiving component 220 may receive clinical parameters from a healthcare facility. Clinical parameters received from the healthcare facility are non-modifiable by other users and are generally associated with certain medical conditions that have a high level of pharmaceutical need (so-called pharmaceutical conditions). These pharmaceutical conditions include patients with infections who are on antibiotics, patients who are on anticoagulants, patients receiving nutritional supplements such as total parenteral nutrition (nutrition maintained entirely by intravenous injection), oncology patients on chemotherapeutic agents, patients receiving end-of-life or palliative care, and patients with renal problems or who are at risk for renal problems. The fact that clinical parameters received from healthcare facilities are non-modifiable is important from a continuity-of-care perspective—it is important that any pharmacist who is seeing a patient on the pharmacy work queue because of a pharmaceutical condition be looking at the same set of clinical parameters.

The healthcare facility may set different clinical parameters for each pharmaceutical condition. By way of illustrative example, the healthcare facility may set clinical parameters requiring all patients with a renal risk level above a certain threshold to be on a pharmacy work queue. The renal risk level of a patient may be based upon, for example, the patient taking a renally excreted drug, the urine output of the patient, or a blood creatinine or BUN above a certain level.

In one embodiment, the receiving component 220 may be configured to receive requests for a pharmacy work queue to be generated. The requests are generally received from one or more pharmacists and/or pharmacy support staff affiliated with the healthcare facility. In one embodiment, authentication of the pharmacists and/or pharmacy support staff is required before a request may be received.

The identifying component 222 may be configured to identify patients at the healthcare facility who satisfy the clinical parameters received by the receiving component 220. In one embodiment, the identifying component 222 identifies the patients who satisfy the clinical parameters by accessing clinical information in the EMR 212. The clinical information may include general patient information, current orders, lab results, diagnoses, and the like. Once the clinical information is accessed, the identifying component 222 compares the clinical information to the clinical parameters received by the receiving component 220. Next, the identifying component 222 determines that the clinical information is related to the clinical parameters. The identifying component 222 then identifies the patients at the healthcare facility that are associated with the clinical information that is related to the clinical parameters.

By way of illustrative example, a clinical parameter is a positive microbiology result. The identifying component 222 accesses clinical information in the EMR 212 dealing with microbiology results. It then determines which microbiology results are positive. Next, the identifying component 222 identifies the patients associated with the positive microbiology results.

In another embodiment of the invention, the identifying component 222 may be configured to identify clinical indicator alerts associated with the clinical parameters. A clinical indicator alert is a set of criteria that, if met, alert the pharmacist that patients on the pharmacy work queue have a particular pharmaceutical concern that needs to be addressed by the pharmacist. Clinical indicator alerts may be generated for a wide variety of reasons including clinician-ordered pharmacy consults, certain medications with a high risk of side-effects, and the possibility of adverse drug reactions between medications. Clinical indicator alerts may also be generated based on lab results indicating that a medication is at a sub-therapeutic level, or is above a therapeutic level, lab results indicating that a patient is suffering some type of harm from a medication, patient risk score assessments that exceed a set threshold, microbiology results indicating that a bacteria is not responding to a certain antibiotic, and many more.

The identifying component 222 may be configured to determine patients on a pharmacy work queue that satisfy the clinical indicator alerts by, for example, accessing clinical information associated with the patients. The identifying component 222 may compare the clinical information associated with the patients with the set of criteria associated with the clinical indicator alert. The identifying component may then determine that the clinical information satisfies the set of criteria. By way of illustrative example, a clinical indicator alert for Vancomycin is triggered if a serum level for the medication is greater than 40 mcg/ml (this comprises a set of criteria for the clinical indicator alert for Vancomycin). The identifying component 222 accesses Vancomycin serum levels for patients that are on the pharmacy work queue and compares the serum levels to the set of criteria for the clinical indicator alert (serum level greater than 40 mcg/ml). The identifying component 222 then determines which patients have serum levels of Vancomycin greater than 40 mcg/ml.

The generating component 224 is configured to generate for display the pharmacy work queue. For example, the pharmacy work queue may be displayed on the display screen 216 of the end-user computing device 214 or on any of the remote computers 108 of FIG. 1. The pharmacy work queue comprises an indication of patients who satisfy the clinical parameters received by the receiving component 220. The pharmacy work queue may be displayed in the form of a graphical user interface. This aspect will be explained in greater depth below.

In another embodiment of the invention, the generating component 224 may be configured to generate for display on the pharmacy work queue clinical indicators alerts. As mentioned, the clinical indicator alerts are generated and displayed for those patients with a particular pharmaceutical concern. The clinical indicator alerts may be displayed on the display screen 216 of the end-user computing device 214 or any of the remote computers 108 of FIG. 1. As well, the clinical indicator alerts may be displayed in the form of a graphical user interface.

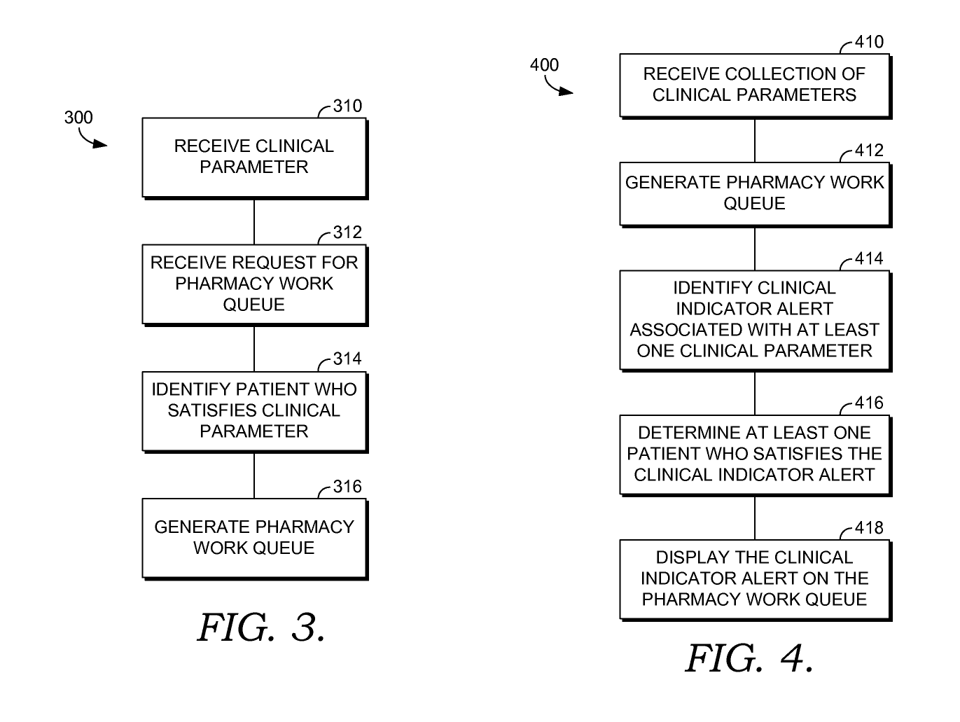

Turning now to FIG. 3, referenced generally by the numeral 300, a flow diagram is depicted illustrating a method of generating a pharmacy work queue. At a step 310, clinical parameters are received by, for example, the receiving component 220 of FIG. 2. The clinical parameters may be received from pharmacists or from a healthcare facility. Clinical parameters received from the healthcare facility may be associated with specific pharmaceutical conditions and may be non-modifiable by other users. The pharmaceutical conditions may include antibiotics, anticoagulants, nutrition, oncology, palliative care, and/or renal care. Clinical parameters received from the pharmacists may differ from pharmacist to pharmacist depending on need and may include location, activities, orders, laboratory, microbiology, or diagnosis.

At a step 312, a request is received for a pharmacy work queue. Again, the request may be received by the receiving component 220 of FIG. 2. The request may be received from a pharmacist and/or pharmacy support staff. In one embodiment, authentication of the pharmacist and/or the pharmacy support staff is required before the request may be received.

At a step 314, patients at a healthcare facility are identified (by, e.g., the identifying component 222 of FIG. 2) who satisfy the clinical parameter. Patients may satisfy the clinical parameter if clinical information associated with the patient matches the clinical parameter. The clinical information may be accessed from an electronic medical record such as, for example, the EMR 212 of FIG. 2. At a step 316, the pharmacy work queue is generated and displayed by, for example, the generating component 224 of FIG. 2. The pharmacy work queue comprises an indication of the patients who satisfy the clinical parameter. The pharmacy work queue may be displayed in the form of a graphical user interface.

Turning to FIG. 4, referenced generally by the numeral 400, a flow diagram is depicted illustrating a method of generating clinical indicator alerts for a pharmacist at a healthcare facility. At a step 410, clinical parameters are received from, for example, a pharmacist or a healthcare facility. At a step 412, a pharmacy work queue is generated and displayed; the pharmacy work queue comprises a displayable list of patients at the healthcare facility who satisfy the clinical parameters. The pharmacy work queue is useable by pharmacists to organize their workflows.

At a step 414, clinical indicator alerts associated with the clinical parameters are identified by, for example, the identifying component 222 of FIG. 2. The clinical indicator alerts may be related to adverse drug event rules, consult orders, medication administration, general laboratory results, microbiology results, and/or risk assessment. Each clinical indicator alert consists of a set of criteria.

At a step 416, patients that satisfy the clinical indicator alerts are determined (by, e.g., the identifying component 222 of FIG. 2). A patient that satisfies a clinical indicator alert may be determined by accessing clinical information associated with the patient and comparing the clinical information with the set of criteria associated with the clinical indicator alert. A patient satisfies the clinical indicator alert if the patient's clinical information satisfies the set of criteria. At a step 418, the clinical indicator alerts are displayed on the pharmacy work queue by, for example, the generating component 224 of FIG. 2.

In one embodiment of the invention, an indication is received that the clinical indicator alert has been acted upon by a pharmacist. The indication may be received by the receiving component 220 of FIG. 2. The pharmacist may act on a clinical indicator alert in a number of ways depending on the nature of the clinical indicator alert. For example, if the clinical indicator alert is a clinician-ordered pharmacy consult, the pharmacist acts on the alert by meeting with the patient and counseling the patient with respect to the patient's pharmaceutical care. In another example, the clinical indicator alert indicates that a medication is at a sub-therapeutic level; the pharmacist acts on the clinical indicator alert by increasing the dosage of the medication. Incident to receiving the indication that the clinical indicator alert has been acted upon by the pharmacist, the clinical indicator alert is removed from the pharmacy work queue by, for example, the generating component 224 of FIG. 2.

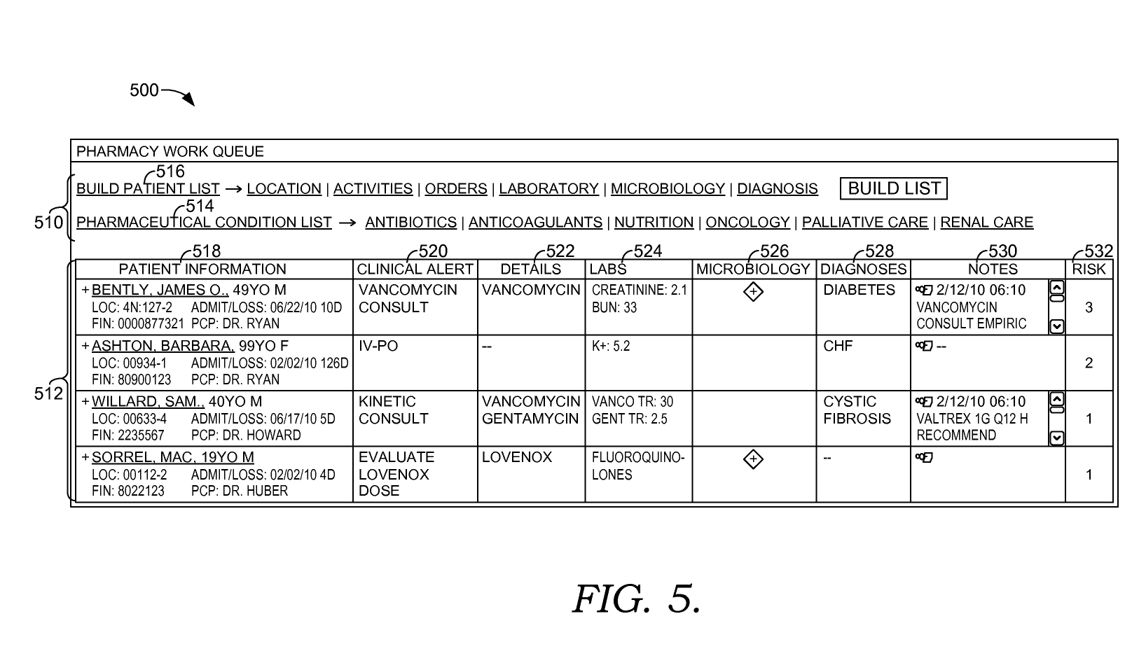

Turning now to FIG. 5, an exemplary graphical user interface (GUI), referenced generally by the numeral 500, for displaying a pharmacy work queue is depicted. This is just one example of a GUI for displaying a pharmacy work queue and is not meant to be limiting in any way. GUI 500 comprises a build list display area 510 configured to enable a user to select clinical parameters. In addition, GUI 500 also comprises a pharmacy work queue display area 512 configured to display a list of patients who satisfy the clinical parameters.

The build list display area 510 further comprises a pharmaceutical condition display area 514 configured to enable the user to select a pharmaceutical condition from a set of pharmaceutical conditions. The set of pharmaceutical conditions in the pharmaceutical condition display area 514 include antibiotics, anticoagulants, nutrition, oncology, palliative care, and renal care. As discussed above, the clinical parameters associated with each of these pharmaceutical conditions may be set by the healthcare facility and may be non-modifiable by the user. Thus, if the user selects the “nutrition” button, a pharmacy work queue may be generated that comprises those patients at the healthcare facility who meet the clinical parameters specified by the healthcare facility for “nutrition.” Clinical parameters for pharmaceutical conditions may vary between different healthcare facilities.

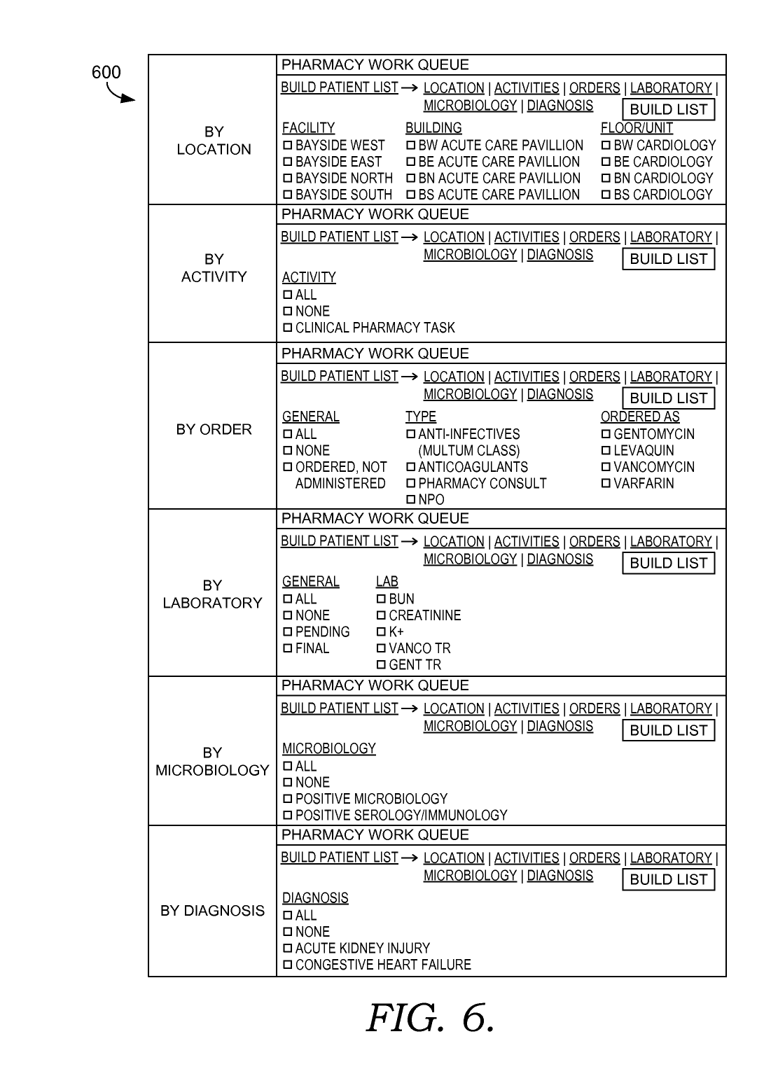

The build list display area 510 also comprises a customized list builder display area 516. The customized list builder display area 516 enables a user to select one or more clinical parameters to create or build a customized pharmacy work queue. The clinical parameters include location, activities, orders, laboratory, microbiology, and diagnosis. The user can select as many clinical parameters as the user wishes to create a customized pharmacy work queue. Once the user selects a clinical parameter, the user is further enabled to select additional options regarding that clinical parameter. A non-exhaustive list of additional options arranged by clinical parameter is shown in the GUI 600 of FIG. 6. The options shown in FIG. 6 are merely examples and are not meant to be limiting in any way. The user can select as many of the additional options as desired. The result is a truly customized pharmacy work queue that meets the user's needs.

Turning back to FIG. 5, in one embodiment, the pharmacy work queue display area 512 may comprise one or more of a patient information display area 518, a clinical indicator alert display area 520, a detail display area 522, a lab results display area 524, a microbiology display area 526, a diagnosis display area 528, a communication notes display area 530, and a risk display area 532.

In general, the patient information display area 518 comprises general patient information including, but not limited to, name, location within the healthcare facility, date of birth, gender, admission date, patient identification number, and/or primary care physician. In one embodiment, a user can select a patient's name and access and view the patient's electronic medical record from, for example, the EMR 212 of FIG. 2.

The clinical indicator alert display area 520 may be configured to display clinical indicator alerts for patients on the pharmacy work queue. As outlined above, the clinical indicator alerts notify pharmacists of specific pharmaceutical concerns. In one embodiment, the clinical indicator alerts remain displayed in the clinical indicator alert display area 520 until a pharmacist takes some type of affirmative action that addresses the pharmaceutical concern (i.e., until an indication is received that the clinical indicator alert has been acted upon by the pharmacist). Once an indication is received that the pharmacist has addressed the clinical indicator alert for a patient, the clinical indicator alert is no longer displayed in the clinical indicator alert display area 520. In another embodiment, the clinical indicator alerts may be highlighted in some manner to help draw the pharmacist's attention to the clinical indicator alert display area 520. Highlighting includes using different fonts, different colors, and other well-known means for drawing a user's attention to a certain area. In yet another embodiment, look-back times can be set for each clinical indicator alert. Thus, a pharmacist will receive a notification (i.e., via e-mail) at the specified time notifying the pharmacist that he or she needs to address the clinical indicator alert.

The detail display area 522 may be configured to display detail information about the clinical indicator alerts. By way of illustrative example, a clinical indicator alert indicates the need for a pharmacy consult. The detail display area 522 corresponding to the clinical indicator alert provides information concerning who was the ordering clinician, when the order was entered into the EMR, and details of the consult order. In another illustrative example, a clinical indicator alert indicates that a serum level of Vancomycin is sub-therapeutic. The detail display area 522 corresponding to this clinical indicator alert provides information concerning the patient's current dosage of Vancomycin, when the dose was last administered, any renal problems the patient has, and the like.

The labs result display area 524 may be configured to display lab results for the patients on the pharmacy work queue. These may be general lab results for the patient or, alternatively, lab results specific to a clinical parameter used to generate the pharmacy work queue. For example, if the patient is on a pharmacy work queue because the patient suffers from renal disease, the lab results may include BUN and creatinine levels (BUN and creatinine levels provide an indication of renal health). In another example, if the patient is on a pharmacy work queue because the patient is taking antibiotics for an infection, the lab results display area 524 may display lab results that include a white blood cell count (WBC).

Continuing, the microbiology display area 526 may be configured to display microbiology lab results for patients on the pharmacy work queue. The microbiology lab results may include culture results, antibiotic sensitivity results, and the like. In turn, the diagnosis display area 528 may be configured to display diagnoses for the patients on the pharmacy work queue.

The communication notes display area 530 may be configured to display communication notes in the form of user-inputted textual information associated with patients on the pharmacy work queue. The communication notes display area 530 may also be configured to enable a user to generate a communication note. In one embodiment, the communication notes are utilized to provide a communication path between the different pharmacists who follow the patients on the pharmacy work queue. Thus, the notes may contain information concerning, for example, how a clinical indicator alert was addressed by a pharmacist, follow-up information, reminders to other pharmacists following the patients, and the like.

In one embodiment, the communication notes may be part of a communication log that consists of current notes as well as previous notes; the communication log may be stored in an EMR. The communication notes may be arranged in reverse chronological order. Current and previous communication notes may be displayed as icons, and when a user selects an icon, the complete communication note is displayed. Still further, each communication note may include information concerning who wrote the communication note and when it was written. In one embodiment, the communication note display area 530 is accessible to any clinician providing care to the one or more patients on the pharmacy work queue. In another embodiment, the communication note display area 530 is only accessible to pharmacists or their support staff.

The risk display area 532 may be configured to display a risk assessment score for patients on the pharmacy work queue. The risk assessment score for a patient is calculated based on a set of rules, and the score gives an indication of the degree of risk a patient has for a specific condition. For example, a risk assessment score may be displayed for patients suffering from renal disease or patients who have a higher than normal likelihood of suffering from renal disease. Continuing with this example, a calculated risk assessment score of 3 may indicate that a patient is currently suffering from renal disease and needs to be closely followed especially if the patient is on renally-excreted drugs. On the other hand, a calculated risk assessment score of 1 may indicate that a patient is not currently suffering from renal disease but needs to be monitored because the patient is currently taking a renally-excreted drug. The actual calculation of risk assessment scores is outside the scope of the current invention.

In one aspect of the invention, display areas 518, 520, 522, 524, 526, 528, 530, and 532 are arranged in columns within the same viewable area. The columns may be filterable by date, location, name, diagnosis, clinical indicator alert, and the like. The columns are further divided into rows, with each row comprising clinical information for one patient. This arrangement enables a pharmacist who is viewing the GUI 500 to easily discern relationships between the different display areas. For example, the pharmacist may see that the patient James O. Bently needs a Vancomycin pharmacy consult. Looking along the row corresponding to Mr. Bently, the pharmacist also sees that Mr. Bently has a risk assessment score of 3 indicating that Mr. Bently suffers from fairly significant renal disease, and that Mr. Bently has diabetes. Continuing, the pharmacist can easily check the lab results display area 524 to view Mr. Bently's BUN and creatinine levels. Finally, the pharmacist can view any pertinent notes regarding Mr. Bently in the communication notes display area 530, or the pharmacist can generate a note regarding Mr. Bently.

The information displayed on GUI 500 and, specifically, display areas 518, 520, 522, 524, 526, 528, 530, and 532 is updated in near real-time. Thus, a pharmacist always has the most up-to-date information to help guide her decision processes. The information displayed on GUI 500 is updated, for example, by accessing an electronic medical record such as, for example, the EMR 212 of FIG. 2.

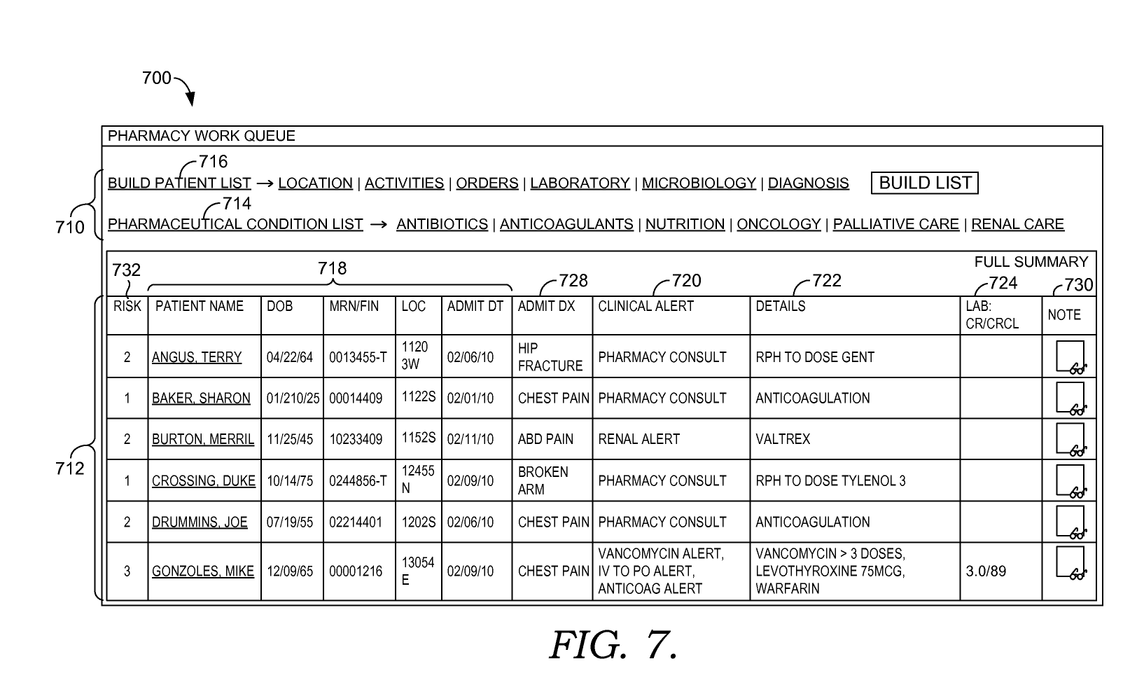

Turning now to FIG. 7, an exemplary graphical user interface (GUI), referenced generally by the numeral 700, for displaying a pharmacy work queue is depicted. More specifically, GUI 700 displays a renal pharmacy work queue. As can be seen, GUI 700 comprises a build list display area 710 that, in turn, comprises a pharmaceutical condition display area 714 and a customized build list display area 716. To generate GUI 700, a pharmacist would select the “renal care” button in the pharmaceutical condition display area 714.

GUI 700 also comprises a pharmacy work queue display area 712 that displays a list of patients who meet the clinical parameters specified by a healthcare facility for “renal care.” The pharmacy work queue display area 714 comprises a patient information display area 518, a diagnosis display area 728, a clinical indicator alert display area 720, a detail display area 722, a lab results display area 724, a communication notes display area 730, and a risk display area 732. As can be seen, the layout of GUI 700 differs slightly from GUI 500 of FIG. 5 because a renal pharmacy work queue may have slightly different information requirements than a pharmacy work queue generated for another purpose. Any and all such variations are within the scope of embodiments of the present invention.

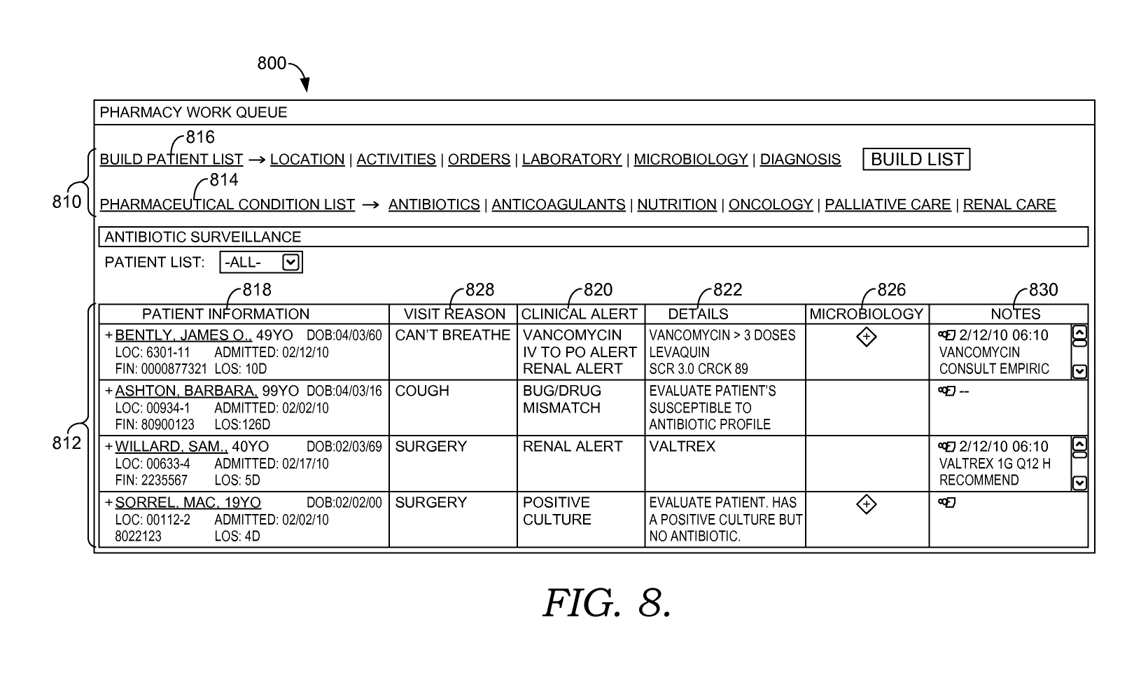

Turning now to FIG. 8, another exemplary graphical user interface (GUI), referenced generally by the numeral 800, for displaying a pharmacy work queue is depicted. GUI 800 is an example of an antibiotic pharmacy work queue. As with GUI 700, GUI 800 comprises a build list display area 810 that, in turn, comprises a pharmaceutical condition display area 814 and a customized build list display area 816. To generate GUI 800, a pharmacist would select the “antibiotics” button in the pharmaceutical condition display area 814.

GUI 800 also comprises a pharmacy work queue display area 812 that displays a list of patients who meet the clinical parameters specified by a healthcare facility for “antibiotics.” The pharmacy work queue display area 814 comprises a patient information display area 818, a diagnosis display area 828, a clinical indicator alert display area 820, a detail display area 822, a microbiology display area 826, and a communication notes display area 830. The layout of GUI 800 differs slightly from GUI 500 of FIG. 5 and GUI 700 of FIG. 7 because of the unique requirements for an antibiotic pharmacy work queue. Any and all such variations are within the scope of embodiments of the present invention.

GUIs 500, 700, and 800 are just three examples of pharmacy work queues. The layout of these GUIs is dependent upon the clinical parameters either selected by a pharmacist or set by a healthcare facility. Depending upon the clinical parameters selected, multiple different GUIs with different layouts will be generated. Any and all such variations are within the scope of embodiments of the present invention.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer storage media having computer-executable instructions embodied thereon that, when executed, facilitate a method of generating a pharmacy work queue, the method comprising:
receiving at least one clinical parameter;
receiving a request for a pharmacy work queue;
identifying at least one patient at a healthcare facility who satisfies the at least one clinical parameter; and
generating for display the pharmacy work queue, the pharmacy work queue comprising an indication of the at least one patient who satisfies the at least one clinical parameter.

2. The computer storage media of claim 1, wherein the pharmacy work queue is a displayable list of patients at the healthcare facility with pharmaceutical needs, the pharmacy work queue useable by a pharmacist to organize the workflow of the pharmacist.

3. The computer storage media of claim 2, wherein the at least one clinical parameter is received from the healthcare facility and is associated with at least one of antibiotics, anticoagulants, nutrition, oncology, palliative care, or renal care.

4. The computer storage media of claim 3, wherein the at least one clinical parameter received from the healthcare facility is non-modifiable by a user.

5. The computer storage media of claim 2, wherein the at least one clinical parameter is received from the pharmacist and is associated with at least one of location, activities, orders, laboratory, microbiology, or diagnosis.

6. The computer storage media of claim 2, wherein the request for the pharmacy work queue is received from the pharmacist.

7. The computer storage media of claim 2, wherein identifying the at least one patient at the healthcare facility who satisfies the at least one clinical parameter comprises:
accessing clinical information in an electronic medical record;
comparing the clinical information to the at least one clinical parameter;
determining that the clinical information is related to the at least one clinical parameter; and
identifying the at least one patient at the healthcare facility associated with the clinical information.

8. One or more computer storage media having computer-executable instructions embodied thereon that, when executed, facilitate a method of generating clinical indicator alerts for a pharmacist at a healthcare facility, the method comprising:
receiving a collection of clinical parameters;
generating for display a pharmacy work queue comprising a displayable list of patients at the healthcare facility who satisfy the collection of clinical parameters;
identifying at least one clinical indicator alert associated with the at least one clinical parameter;
determining that at least one patient of the list of patients satisfies the at least one clinical indicator alert; and
generating for display on the pharmacy work queue the clinical indicator alert.

9. The computer storage media of claim 8, wherein the at least one clinical indicator alert is related to adverse drug event rules, consult orders, medication administration, general laboratories results, microbiology results, or risk assessment.

10. The computer storage media of claim 8, wherein the at least one clinical indicator comprises a set of criteria.

11. The computer storage media of claim 10, wherein determining that the at least one patient satisfies the at least one clinical indicator alert comprises:
accessing clinical information associated with the at least one patient;
comparing the clinical information with the set of criteria; and
determining that the clinical information satisfies the set of criteria.

12. The computer storage media of claim 8, further comprising:
receiving an indication that the clinical indicator alert has been acted upon by the pharmacist.

13. The computer storage media of claim 12, wherein incident to receiving the indication that the clinical indicator alert has been acted upon by the pharmacist, removing the clinical indicator alert from the pharmacy work queue.

14. One or more computer storage media, executable by a computing device, to display a graphical user interface for displaying a pharmacy work queue, the graphical user interface comprising:
a build list display area configured to enable a user to select at least one clinical parameter from a set of clinical parameters; and
a pharmacy work queue display area configured to display a list of patients who satisfy the at least one clinical parameter.

15. The computer storage media of claim 14, the build list display area further comprising:
a pharmaceutical condition display area configured to enable the user to select at least one pharmaceutical condition from a set of pharmaceutical conditions, wherein the set of pharmaceutical conditions include antibiotics, anticoagulants, nutrition, oncology, palliative care, or renal care; and
a customized list builder display area that enables the user to select at least one clinical parameter from a set of clinical parameters, wherein the set of clinical parameters include location, activities, orders, laboratory, microbiology, and diagnosis

16. The computer storage media of claim 15, wherein incident to the user selecting at least one clinical parameter from the set of clinical parameters, the user is further enabled to select additional options for the at least one clinical parameter.

17. The computer storage media of claim 14, the pharmacy work queue display area further comprising one or more selected from the following:
a patient information display area configured to display identification information associated with the list of patients;
a clinical indicator alert display area configured to display clinical indicator alerts;
a detail display area configured to display details about the clinical indicator alerts;
a lab results display area configured to display lab results associated with the list of patients;
a microbiology display area configured to display microbiology results associated with the list of patients;
a diagnosis display area configured to display diagnoses associated with the list of patients;
a communication notes display area configured to display user-inputted textual information associated with the list of patients; and
a risk display area configured to display a risk assessment score associated with the list of patients.

18. The computer storage media of claim 17, wherein the patient information display area, the clinical indicator alert display area, the detail display area, the lab results display area, the microbiology display area, the diagnosis display area, the communication notes display area, and the risk display area are updated in near real-time.

19. The computer storage media of claim 17, wherein the patient information display area enables the user to access an electronic medical record associated with a patient within the list of patients.

20. The computer storage media of claim 17, wherein the patient information display area, the clinical indicator alert display area, the detail display area, the lab results display area, the microbiology display area, the diagnosis display area, the communication notes display area, and the risk display area are arranged in columns within the same viewable area.
